(19) United States
(12) Patent Application Publication
(10) Pub. No.: US 2011/0307090 A1
(43) Pub. Date: Dec. 15, 2011

(54) Tolerance analyzing apparatus, designing apparatus, viewer apparatus, and assembly order converting method

(75) Inventors: Kazuhiko Hamazoe, Kawasaki (JP); Yoshikazu Ichikawa, Kawasaki (JP); Yukari Sato, Kawasaki (JP)

(73) Assignee: FUJITSU LIMITED, Kawasaki (JP)

(21) Appl. No.: 13/064,420

(22) Filed: Mar. 23, 2011

(30) Foreign Application Priority Data
Jun. 9, 2010 (JP) 2010-132225

(51) Int. Cl. G06F 19/00

(52) U.S. Cl. 700/104

(57) ABSTRACT

A tolerance analyzing apparatus for performing a tolerance analysis based on design data includes an assembly definition unit that allows a user to make an assembly definition and define a degree of freedom for a constituent component, and a determination unit determining a datum type corresponding to a count value based on a datum determination reference table. The determination unit obtains the count value by counting a number of normals having the same direction at an assembly location of the constituent component, a constrained degree of translational freedom in the normal direction, and a constrained degree of rotational freedom about an axis perpendicular to the normal based on the assembly definition and the degree of freedom of the constituent component. The apparatus also includes an output unit that outputs the datum type determined by the determination unit.

### CROSS-REFERENCE TO RELATED APPLICATIONS

This application is based upon and claims the benefit of priority of Japanese Patent Application 2010-132225, filed on Jun. 9, 2010, the entire contents of which are incorporated herein by reference.

### FIELD

The present invention relates to tolerance analyzing apparatuses, designing apparatuses, assembly order converting methods, and non-transitory computer-readable recording media having an assembly order converting program.

### BACKGROUND

An assembled product typically has dimensional variations (design specification values) due to the build-up of dimensional tolerances of the constituent components of the product during assembly. Such dimensional variations may be verified in an upper process of design, for example, using a tolerance analyzing apparatus based on three-dimensional CAD data. This is so that the quality of the designed product can be improved by setting optimum dimensional tolerances or an assembly order that can reduce the build-up of dimensional tolerances. Japanese Laid-Open Patent Publication No. 2008-46924 discusses a technology for automatically generating from a 3D-CAD assembly model all assembly sequences that satisfy a certain level of assembly workability.

When a designer issues assembly instructions for the lower process of manufacture or assembly, a video of assembly instructions may be created using a three-dimensional feature viewer apparatus, so that the instructions can be given in a visually easy-to-understand, clear manner.

### SUMMARY

In one aspect of the present invention, a tolerance analyzing apparatus for performing a tolerance analysis based on design data includes an assembly definition unit that allows a user to make an assembly definition and define a degree of freedom for a constituent component; a determination unit that determines a datum type corresponding to a count value based on a datum determination reference table. The determination unit obtains the count value by counting a number of normals having the same directions at an assembly location of the constituent component, a constrained degree of translational freedom in the normal direction, and a constrained degree of rotational freedom about an axis perpendicular to the normal based on the assembly definition and the degree of freedom of the constituent component. The tolerance analyzing apparatus also includes an output unit that outputs the datum type determined by the determination unit.

In another aspect, a computer-aided designing apparatus includes a design data generating unit that enables a user to make a design and that generates design data, and a tolerance analyzing unit that performs tolerance analysis based on the design data. The tolerance analyzing unit includes an assembly definition unit that allows the user to make an assembly definition and define a degree of freedom for a constituent component and a determination unit that determines a datum type corresponding to a count value based on a datum determination reference table. The determination unit obtains the count value by counting a number of same direction normals at an assembly location of the constituent component, a constrained degree of translational freedom in the normal direction, and a constrained degree of rotational freedom about an axis perpendicular to the normal based on the assembly definition and the degree of freedom of the constituent component. The tolerance analyzing unit also includes an output unit that outputs the datum type determined by the determination unit.

In another aspect, a viewer apparatus for generating an assembly instruction concerning an assembly order of constituent components includes a restructuring unit that restructures constituent component tree information by sorting constituent components in the constituent component tree information according to an assembly order attribute which is allocated to the constituent components based on the assembly order; a list generating unit that generates an assembly order list for the constituent components based on the constituent component tree information restructured by the restructuring unit; and an alerting unit that displays an alert message when the constituent components are selected by a user in an order different from the assembly order list during the generation of the assembly instruction of the assembly order for the constituent components.

In another aspect, an assembly order converting method implemented by a tolerance analyzing apparatus for performing tolerance analysis based on design data includes allowing a user to make an assembly definition and define a degree of freedom for a constituent component; obtaining a count value by counting a number of same direction normals at an assembly location of the constituent component, a constrained degree of translational freedom in a normal direction, and a constrained degree of rotational freedom about an axis perpendicular to the normal based on the assembly definition and the degree of freedom of the constituent component; determining a datum type corresponding to the count value based on a datum determination reference table; outputting the datum type determined by the determining; finalizing an assembly order based on the assembly definition of the constituent component; setting assembly order attribute information based on the finalized assembly order for the constituent component in constituent component tree information based on the finalized assembly order; and allocating an assembly order attribute based on the finalized assembly order to the constituent component having a corresponding name in the constituent component tree information of a designing apparatus.

In another aspect, a non-transitory computer-readable recording medium stores an assembly order converting program for causing a tolerance analyzing apparatus for performing tolerance analysis based on design data to function as an assembly definition unit that allows a user to make an assembly definition and define a degree of freedom for a constituent component, and as a determination unit that determines a datum type corresponding to a count value based on a datum determination reference table. The determination unit obtains the count value by counting a number of same direction normals at an assembly location of the constituent component, a constrained degree of translational freedom in the normal direction, and a constrained degree of rotational freedom about an axis perpendicular to the normal based on the assembly definition and the degree of freedom of the constituent component. The tolerance analyzing apparatus also includes an output unit that outputs the datum type determined by the determination unit, and an assembly order converting unit that, for the constituent component in constituent component tree information based on an assembly order that is finalized according to the assembly definition of the constituent component, sets assembly order attribute information based on the finalized assembly order, and allocates an assembly order attribute based on the finalized assembly order to the constituent component having a corresponding name in the constituent component tree information of a designing apparatus.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an assembly instruction generating system according to an embodiment of the present invention;

FIG. 2 illustrates a hardware structure of a computer that provides the functions of a CAD unit, a tolerance analyzing unit, and a viewer unit in the assembly instruction generating system of FIG. 1;

FIG. 3 is a block diagram of the CAD apparatus;

FIG. 4 is a block diagram of the tolerance analyzing apparatus;

FIG. 5 is a block diagram of the viewer apparatus;

FIG. 6 illustrates the movements of a component in six directions;

FIG. 7 illustrates a first datum;

FIG. 8 illustrates a second datum;

FIG. 9 illustrates a third datum;

FIG. 10 is a table of examples of the first datum;

FIG. 11 is a table of examples of the second datum;

FIG. 12 is a table of an example of the third datum;

FIG. 13A illustrate components A and B subjected to tolerance analysis;

FIG. 13B illustrates the component B;

FIG. 13C illustrates the component A;

FIG. 14 is a table of assembly definition information of the components A and B;

FIGS. 15A through 15C illustrate examples of degree of freedom information;

FIG. 16 is a datum determination reference table;

FIG. 17 is a table of color coordinate information in which features of the first through third datums are color-coded;

FIGS. 18A through 18C illustrate the components A and B to which geometry colors are designated in accordance with the determined datum type;

FIGS. 19A through 19C illustrate examples of constituent component tree information arranged in accordance with an assembly order;

FIG. 20A illustrates the constituent component tree information in the tolerance analyzing unit;

FIG. 20B illustrates the constituent component tree information in the CAD apparatus in which assembly order attributes are allocated to the constituent components;

FIG. 21A illustrates the constituent component tree information in the CAD apparatus in which the assembly order attributes are allocated;

FIG. 21B illustrates restructured constituent component tree information in the viewer apparatus;

FIG. 22 is an example of an assembly order list;

FIG. 23 is a flowchart of a process of determining the first, the second, or the third datum;

FIG. 24 is a flowchart of a process of converting a component assembly order;

FIG. 25 is a flowchart of a process of generating an assembly order list;

FIG. 26 illustrates an example of the constituent component tree information in the CAD apparatus;

FIG. 27 illustrates an assembly model of a highest order;

FIG. 28A through 28D illustrate a component model and assembly models of a second layer;

FIGS. 29A through 29C illustrate the attribute information contained in the constituent component tree information;

FIGS. 30A and 30B illustrate an assembly order in accordance with the constituent component tree information in the CAD apparatus;

FIG. 31 illustrates an assembly order in accordance with the constituent component tree information in the tolerance analyzing apparatus;

FIG. 32A illustrates the constituent component tree information and attribute information in the CAD apparatus;

FIG. 32B illustrates the constituent component tree information and attribute information in the viewer apparatus; and

FIG. 33 illustrates an assembly instruction generating system according to another embodiment of the present invention.

### DESCRIPTION OF EMBODIMENTS

When a tolerance analyzing apparatus and a three-dimensional feature viewer apparatus are not sufficiently coordinated with each other, the result of tolerance analysis cannot be properly and fully reflected in assembly instructions. This occurs when, for example, the tolerance analyzing apparatus lacks a mechanism for outputting information based on the tolerance analysis result to the three-dimensional feature viewer apparatus. The tolerance analysis result may include an assembly order specifying assembly locations or directions that reduces the build-up of dimensional tolerances.

Thus, when creating an assembly instruction video, the designer may be required to manually read the tolerance analysis result provided by the tolerance analyzing apparatus, and manually reflect the tolerance analysis result in the assembly instruction video created by the three-dimensional feature viewer apparatus. During such a manual process, the designer may make an instruction error, and also additional process steps are required.

Preferred embodiments of the present invention will be explained with reference to the accompanying drawings.

### [a] First Embodiment

### (System Structure)

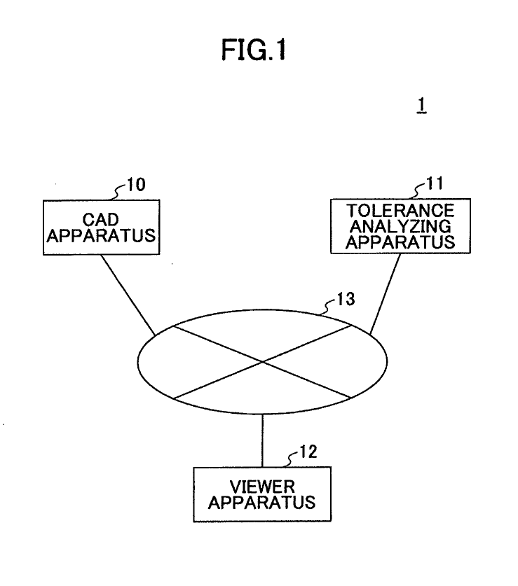

FIG. 1 illustrates an assembly instruction generating system 1 according to an embodiment of the present invention. The assembly instruction generating system 1 includes a CAD (Computer Aided Design) apparatus 10, a tolerance analyzing apparatus 11, and a viewer apparatus 12. The CAD apparatus 10, the tolerance analyzing apparatus 11, and the viewer apparatus 12 are connected via a network 13, which may include the Internet or a LAN (local area network). Thus, data can be communicated among the CAD apparatus 10, the tolerance analyzing apparatus 11, and the viewer apparatus 12.

The CAD apparatus 10, which is a computer-aided design support tool, is used by a designer in designing a product. The CAD apparatus 10 outputs three-dimensional CAD data as a designed result.

The tolerance analyzing apparatus 11 performs a tolerance analysis using the three-dimensional CAD data. The tolerance analysis may include setting dimensional tolerances for various components to be assembled, and calculating dimensional variations of the assembled components. During the tolerance analysis using the three-dimensional CAD data, the tolerance analyzing apparatus 11 determines first through third datums that provide geometric references necessary for regulating the positions and directions of the components, based on an assembly definition and degrees of freedom.

The assembly definition and the degrees of freedom provide information that defines how variations due to the dimensional tolerances of the components are carried over. For example, the assembly definition provides information indicating what features of the components should be assembled together. The degrees of freedom provides information of constrained or non-constrained directions in six directions of mating portions. The tolerance analyzing apparatus 11 color-codes features of the determined first through third datums. The tolerance analyzing apparatus 11 also sets assembly order attribute information indicating an optimized assembly order for constituent component tree information, as will be described later.

The viewer apparatus 12 creates an assembly instruction video indicating an assembly order that reduces the build-up of the dimensional tolerances in an assembled product and the like, based on the three-dimensional CAD data, the assembly order attribute information, and the color information of the features of the color-coded first through third datums.

### (Hardware Structure)

The CAD apparatus 10 may include a computer in which a CAD program is installed. The tolerance analyzing apparatus 11 may include a computer in which an assembly order converting program is installed. The viewer apparatus 12 may include a computer in which a viewer program is installed. A hardware structure of a computer in which the CAD program, the assembly order converting program, or the viewer program is installed is described. The computer is configured to execute the CAD program, the assembly order converting program, or the viewer program in order to provide the functions of the CAD apparatus 10, the tolerance analyzing apparatus 11, or the viewer apparatus 12, respectively, of the present embodiment.

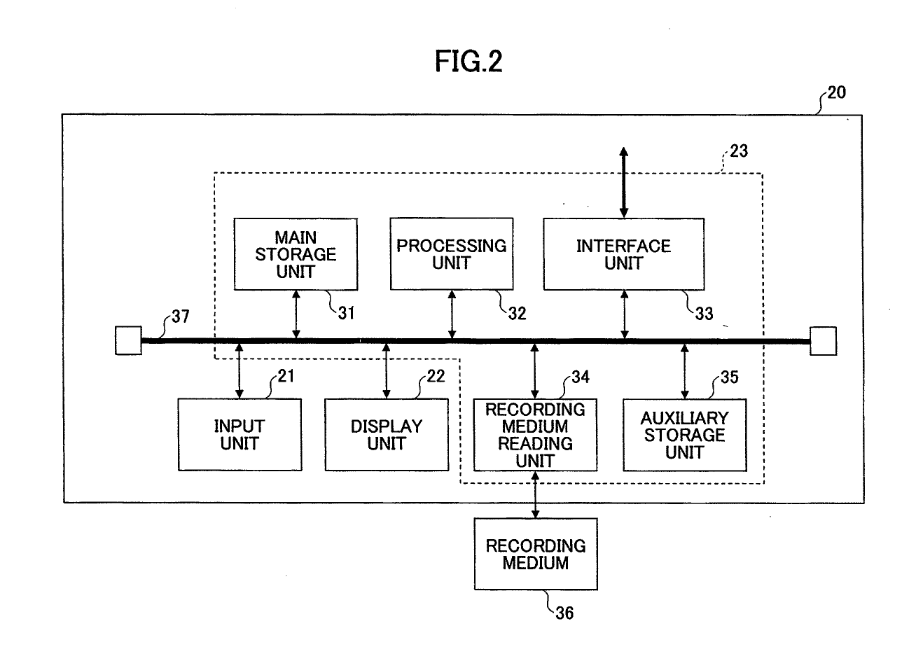

FIG. 2 is a hardware block diagram of a computer 20. The computer 20 includes an input unit 21, a display unit 22, and a computer main body 23. The computer main body 23 includes a main storage unit 31, a processing unit 32, an interface unit 33, a recording medium reading unit 34, and an auxiliary storage unit 35. These units are mutually connected via a bus 37. The input unit 21 and the display unit 22 are also connected to the bus 37. Thus, the input unit 21, the display unit 22, the main storage unit 31, the processing unit 32, the interface unit 33, the recording medium reading unit 34, and the auxiliary storage unit 35 can exchange data via the bus 37, under the control of the processing unit 32. The processing unit 32 may include a central processing unit configured to control operations of the computer 20 as a whole.

The interface unit 33 may receive data from another personal computer or a server, and then deliver the contents of the data to the processing unit 32. The interface unit 33 may also transmit data to the other personal computer or the server in accordance with an instruction from the processing unit 32. The auxiliary storage unit 35 may store a CAD program, an assembly order converting program, or a viewer program for causing the computer 20 to provide the functions of the CAD apparatus 10, the tolerance analyzing apparatus 11, or the viewer apparatus 12, respectively.

Thus, the computer 20 may provide the functions of the CAD apparatus 10, the tolerance analyzing apparatus 11, or the viewer apparatus 12 by reading the CAD program, the assembly order converting program, or the viewer program from the auxiliary storage unit 35 and having them executed by the processing unit 32. The CAD program, the assembly order converting program, or the viewer program may be stored in the main storage unit 31, which the processing unit 32 can access. The input unit 21 receives an input of data under the control of the processing unit 32.

The CAD program, the assembly order converting program, or the viewer program may be recorded in a computer-readable recording medium 36 that can be read by the computer 20. Examples of the computer-readable recording medium 36 include magnetic recording media, optical discs, opto-magnetic recording media, and semiconductor memories. Examples of magnetic recording media include HDDs (hard disk drive), flexible disks (FD), and magnetic tape (MT). Examples of optical discs include DVDs (Digital Versatile Disc), DVD-RAMs, CD-ROMs (Compact Disc Read Only Memory), and CD-Rs (Recordable)/RW (ReWritable). An example of opto-magnetic recording media is a MO (Magneto-Optical disk).

The CAD program, the assembly order converting program, or the viewer program may be distributed through the sales of the recording medium 36 in the form of a DVD or a CD-ROM, for example. The recording medium 36 in which the CAD program, the assembly order converting program, or the viewer program is recorded may be read by the recording medium reading unit 34. The processing unit 32 then stores the CAD program, the assembly order converting program, or the viewer program in the main storage unit 31 or the auxiliary storage unit 35. The CAD program, the assembly order converting program, or the viewer program may be then read from the main storage unit 31 or the auxiliary storage unit 35 and executed by the processing unit 32.

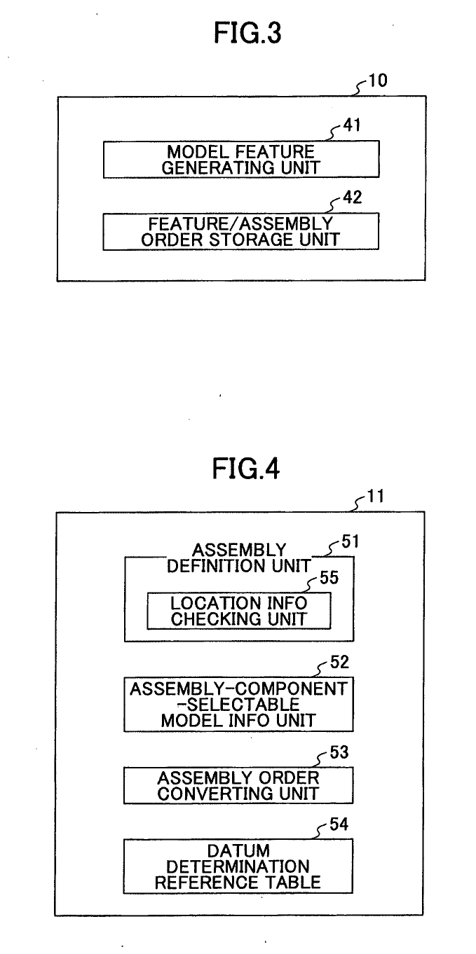

FIG. 3 is a block diagram of the CAD apparatus 10. The CAD apparatus 10 includes a model feature generating unit 41 and a feature/assembly order storage unit 42. The model feature generating unit 41 allows a designer to design a product and the like. The model feature generating unit 41 generates and outputs three-dimensional CAD data as a designed result. The feature/assembly order storage unit 42 also stores the three-dimensional CAD data and the assembly order attribute information.

FIG. 4 is a block diagram of the tolerance analyzing apparatus 11. The tolerance analyzing apparatus 11 includes an assembly definition unit 51, an assembly-component-selectable model information unit (hereafter referred to as a “model information unit”) 52, an assembly order converting unit 53, and a datum determination reference table 54. The assembly definition unit 51 includes a location information checking unit 55.

The assembly definition unit 51 allows the designer to make an assembly definition and define degrees of freedom. The location information checking unit 55 is coordinated with the model feature generating unit 41. The location information checking unit 55 checks the three-dimensional CAD data generated by the model feature generating unit 41 as needed.

The model information unit 52 determines the first, the second, or the third datum for a component based on the assembly definition and the degrees of freedom. The model information unit 52 color-codes features of the determined first through third datums. The assembly order converting unit 53 converts a component assembly order based on the attribute information contained in the constituent component tree information arranged in accordance with the assembly order, and then outputs the converted result. The datum determination reference table 54 is used for determining the datum of the component.

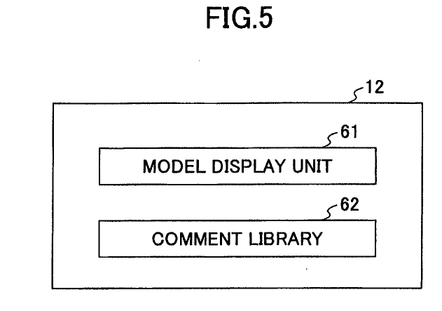

FIG. 5 is a block diagram of the viewer apparatus 12. The viewer apparatus 12 includes a model display unit 61 and a comment library 62. The model display unit 61 generates a assembly order list that can reduce the build-up of dimensional tolerances in an assembled product and the like, based on the constituent component tree information and the assembly order attribute information. The model display unit 61, based on the generated list of the assembly orders, creates an assembly instruction video. At this time, the model display unit 61 acquires a comment corresponding to the color of the features of the first, the second, or the third datum, such as “First datum”, from a comment library 62, and inserts the comment into the component assembly instruction video.

### (Terms)

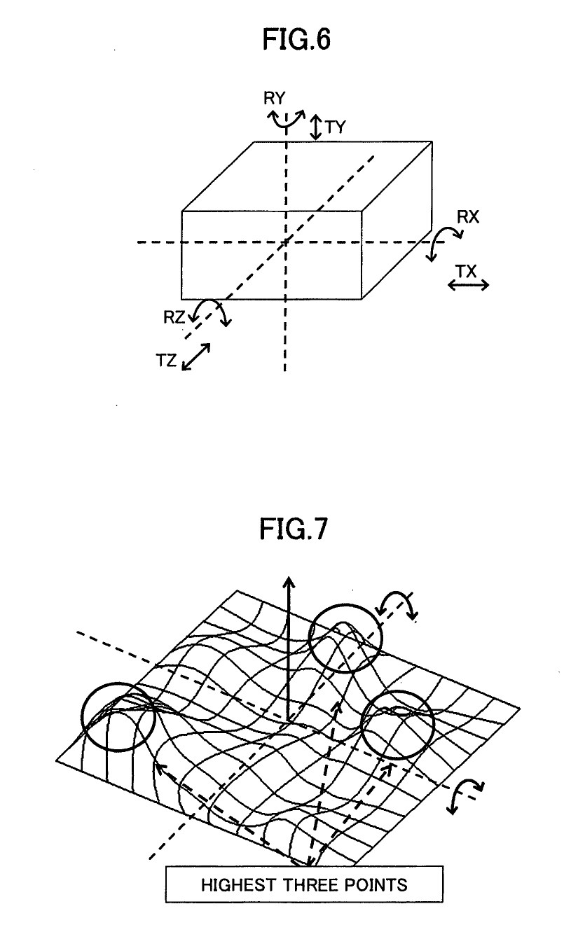

Next, the terms “assembly definition”, “degrees of freedom”, and “datum” are described. The “assembly definition” defines which features of components are used for assembly. The “degrees of freedom” indicates movements of each component in six directions in order to represent a state of assembly of the components. FIG. 6 illustrates the movements of a component in six directions. As illustrated, the component has six degrees of freedom including translation (TX, TY, TZ) along and rotation (RX, RY, RZ) about X, Y, and Z axes.

The “datum” includes elements that provide a reference for assembly, such as a plane, a bore, a projection, and a groove. Because actual assembly involves fixing in three-dimensional directions, the first through third datums are required in order of priority. FIG. 7 illustrates the first datum. The first datum is related to a three high-points contact. The three high-points contact is the first geometric contact condition necessary for a stable mating of actual features. As illustrated in FIG. 7, an actual plane (feature) has surface irregularities, and a stable mating condition is obtained by contact at the three-highest points on the irregular surface. In the case of the three high-points contact, translation in a direction normal to the plane and rotation about axes perpendicular to the normal are constrained.

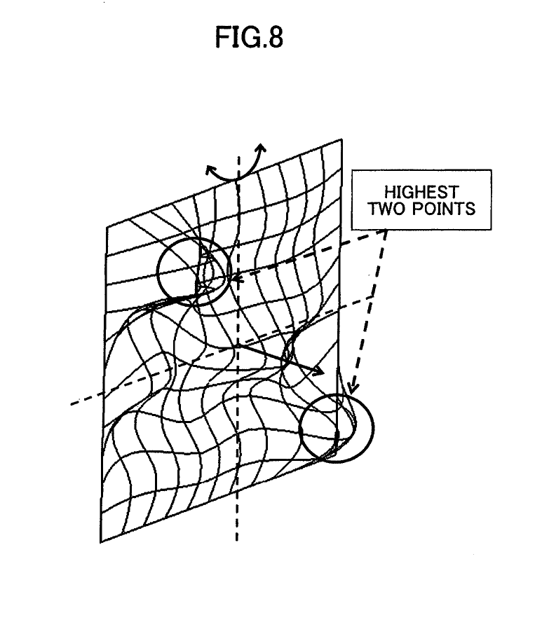

FIG. 8 illustrates the second datum. The second datum is related to a two high-points contact. The two high-points contact is the second geometric contact condition required next to the three high-points contact for a stable mating of actual features. As illustrated in FIG. 8, an actual plane (feature) has surface irregularities. In the case of the two high-points contact, a stable mating condition is obtained by constraining translation in a direction normal to the plane and rotation about an axis perpendicular to the normal by the contacts via the two highest points on the irregular surface, except for the directions constrained by the three high-points contact.

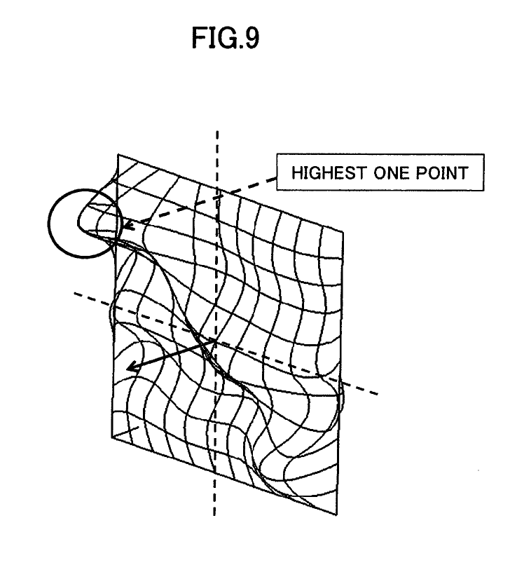

FIG. 9 illustrates the third datum, which is related to a single high-point contact. The single high-point contact is the third geometric contact condition next to the two high-points contact necessary for a stable mating of actual features. As illustrated in FIG. 9, an actual plane (feature) has surface irregularities. In the case of the single high-point contact, a stable mating condition is obtained by constraining translation in a direction normal to the plane via contact at the single highest point on the irregular surface, except for the directions constrained by the three or two high-points contacts.

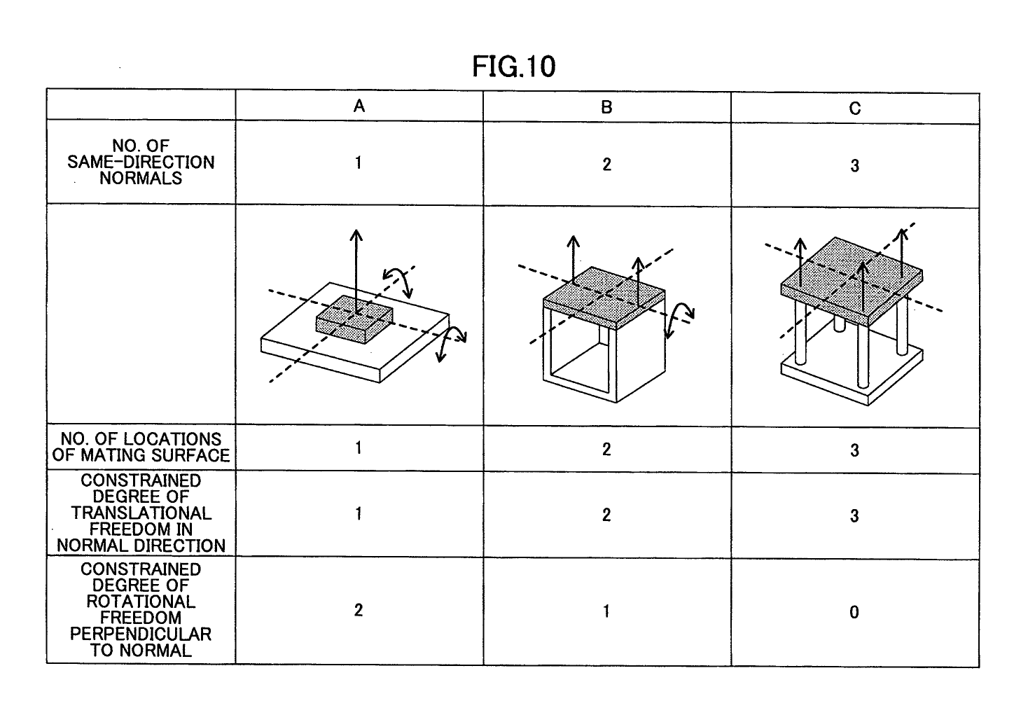

FIG. 10 is a table of examples of the first datum. The first datum A illustrates an example where the number of normals in the same direction is one. In this case, the mating surface is at one location, the number of translational constraints in the normal direction is one, and the number of rotational constraints about axes perpendicular to the normal is two. The first datum B illustrates the first datum where the number of normals in the same direction is two. In this case, the mating surface is at two locations, the number of translational constraints in the normal direction is two, and the number of rotational constraints about axes perpendicular to the normal is one. The first datum C illustrates the first datum where the number of normals in the same direction is three. In this case, the mating surface is at three locations, the number of translational constraints in the normal direction is three, and the number of constraints about axes perpendicular to the normal is zero.

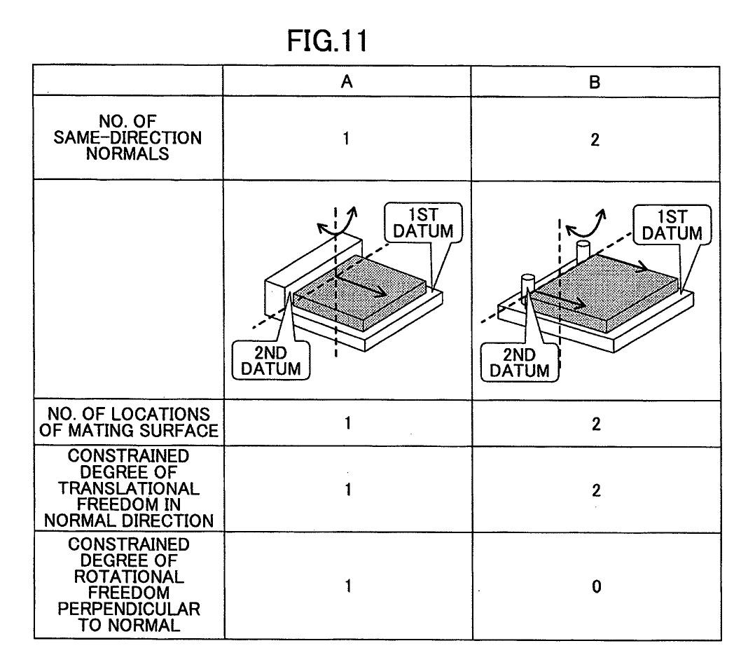

FIG. 11 is a table of examples of the second datum. The second datum A indicates an example where the number of normals in the same direction is one. In this case, the mating surface is at one location, the number of translational constraints in the normal direction is one, and the number of rotational constraints about axes perpendicular to the normal is one. The second datum B illustrates an example where the number of normals in the same direction is two. In this case, the mating surface is at two locations, the number of translational constraints in the normal direction is two, and the number of rotational constraints about axes perpendicular to the normal is zero.

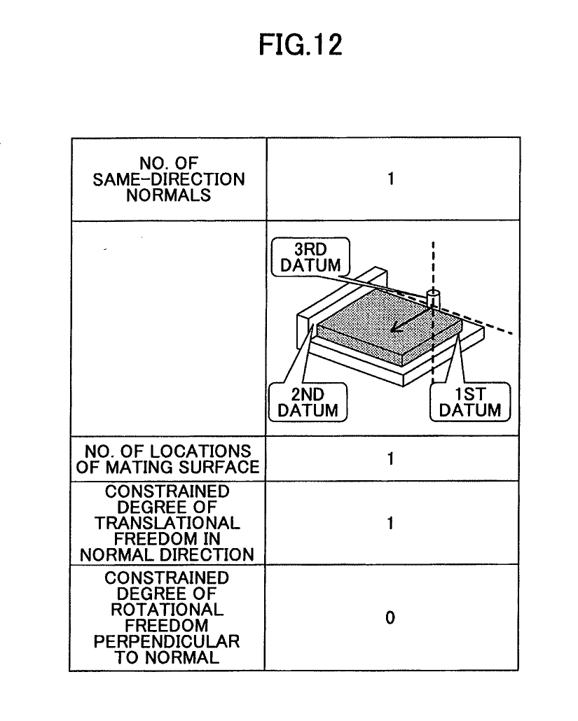

FIG. 12 is a table of an example of the third datum where the number of normals in the same direction is one. In this case, the mating surface is at one location, the number of translational constraints in the normal direction is one, and the number of rotational constraints about axes perpendicular to the normal is zero.

### (Process)

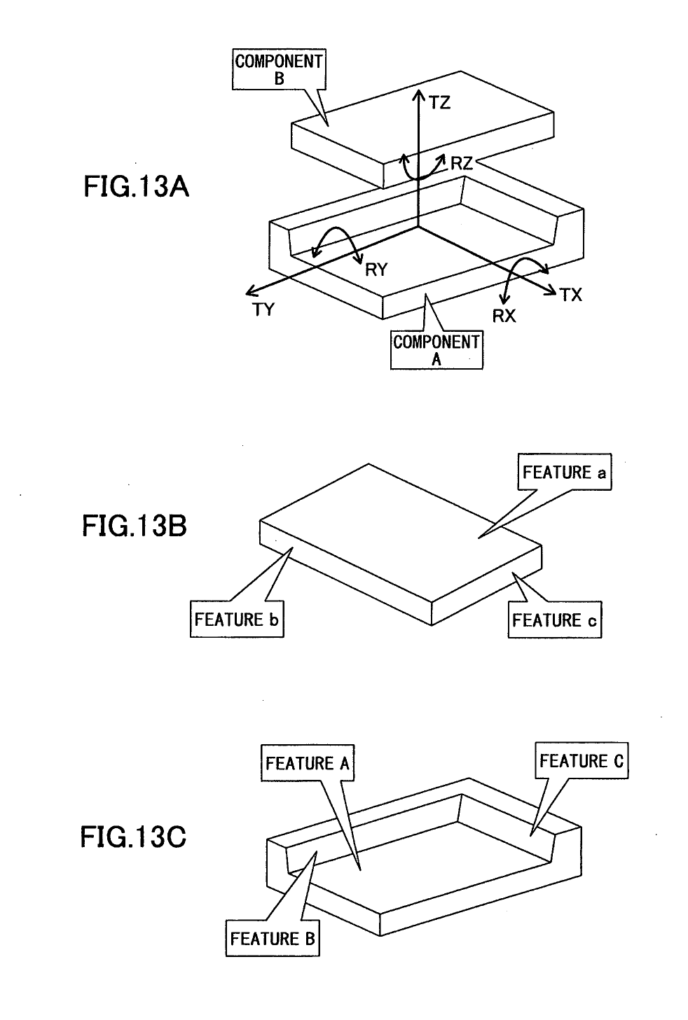

A process performed by the tolerance analyzing apparatus 11 is described with reference to FIGS. 13A through 13C. FIG. 13A illustrates components A and B that are subjected to tolerance analysis. The components A and B are to be assembled together. For the component A, features A through C are defined (FIG. 13C). For the component B, features a through c are defined (FIG. 13B). “TX” indicates a degree of translational freedom in an X-axis direction. “TY” indicates a degree of translational freedom in a Y-axis direction. “TZ” indicates a degree of translational freedom in a Z-axis direction. “RX” indicates a degree of rotational freedom about the X-axis. “RY” indicates a degree of rotational freedom about the Y-axis. “RZ” indicates a degree of rotational freedom about the Z-axis.

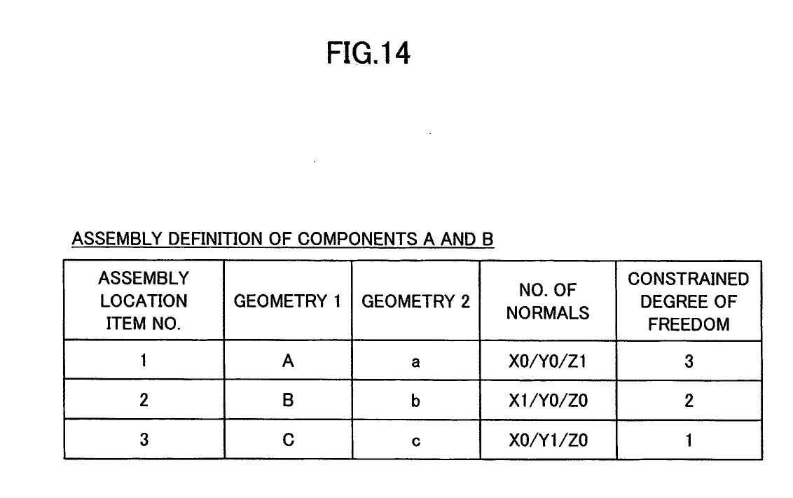

An assembly definition is made and degrees of freedom are defined between the components A and B by the designer. FIG. 14 illustrates an example of the assembly definition information of the components A and B. In the assembly definition information, “geometry 1” indicates a mated feature of the component A, and “geometry 2” indicates a mated feature of the component B. The geometries 1 and 2 are associated with the number of normal directions and the number of constrained degrees of freedom for each assembly location indicated by an “assembly location item number”.

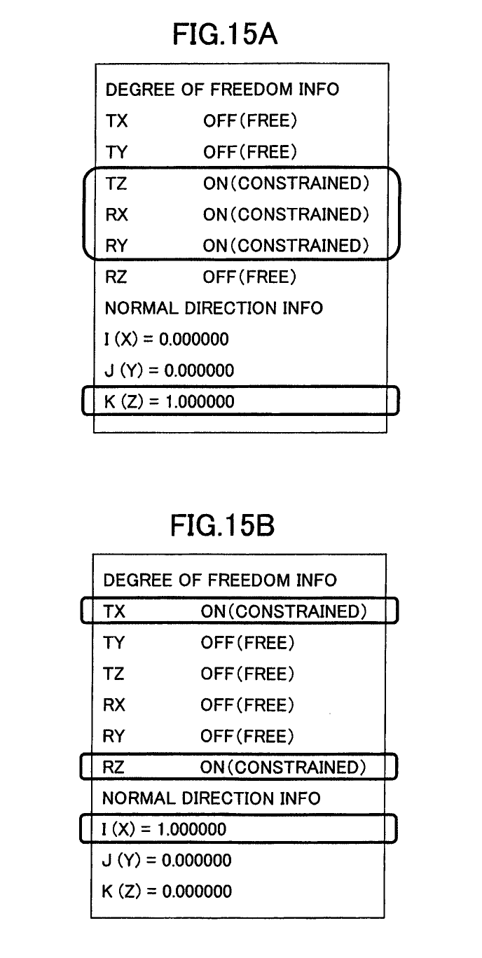

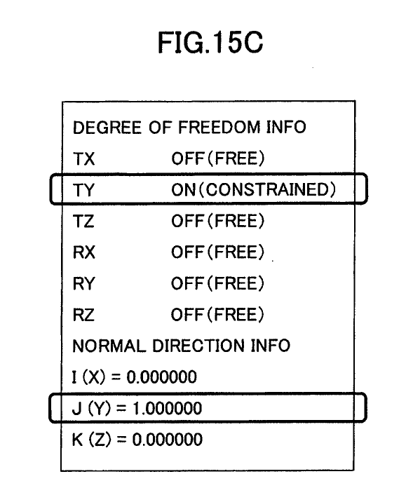

For each assembly location, degree of freedom information is defined as detailed attribute information, as illustrated in FIGS. 15A through 15C. FIG. 15A illustrates an example of the degree of freedom information at an assembly location with the assembly location item number “1”. FIG. 15B illustrates an example of the degree of freedom information at an assembly location with the assembly location item number “2”. FIG. 15C illustrates an example of the degree of freedom information at an assembly location with the assembly location item number “3”.

In the case of FIG. 15A (assembly location item number “1”), there are degrees of freedom in directions perpendicular to the Z direction but TZ, RX, and RY are constrained. In the case of FIG. 15B (assembly location item number “2”), there are degrees of freedom in directions perpendicular to the X direction but TX and RZ are constrained. In the case of FIG. 15C (assembly location item number “3”), there are degrees of freedom in directions perpendicular to the Y direction, but TY is constrained.

The tolerance analyzing apparatus 11, by referring to the assembly definition information (FIG. 14), counts the number of the three normal directions (perpendicular to one another) of each assembly location as the number of the same direction normals. The tolerance analyzing apparatus 11, for each of the counted three normal directions of each assembly location, counts the number of constrained degrees of translational freedom in each normal direction, and the number of the constrained degrees of rotational freedom about axes perpendicular to the normal (i.e., the number of constrained degrees of rotational freedom about axes in directions tangential to the feature).

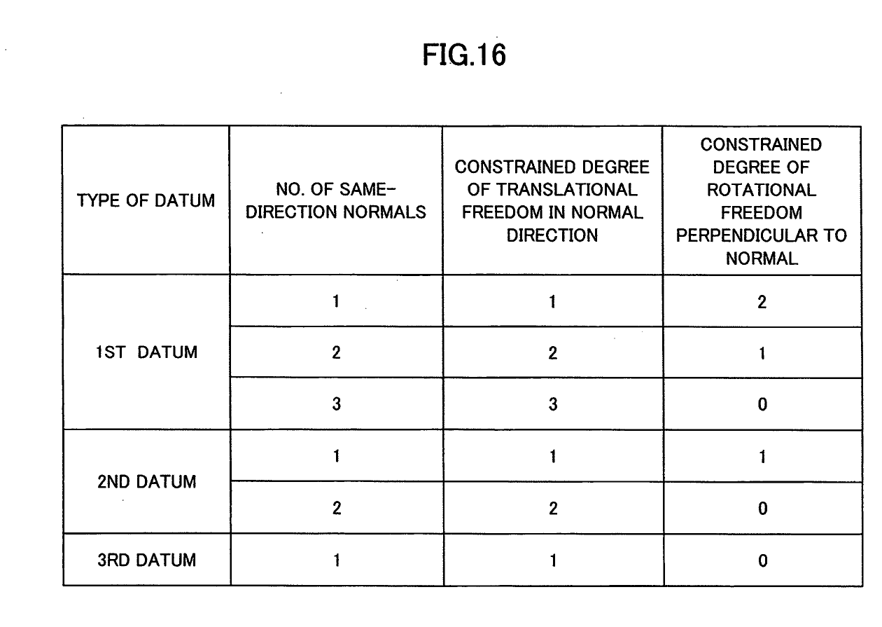

The tolerance analyzing apparatus 11, by referring to a datum determination reference table illustrated in FIG. 16, determines the type of datum corresponding to the number of the same direction normals, the number of constrained degrees of translational freedom in the normal direction, and the number of constrained degrees of rotational freedom about axes perpendicular to the normal that have been counted. In the datum determination reference table of FIG. 16, the types of datum are uniquely associated with the number of the same direction normals, the number of constrained degrees of translational freedom in the normal direction, and the number of constrained degrees of rotational freedom about axes perpendicular to the normal.

For example, in the case of the degree of freedom information of FIG. 15 and the datum determination reference table of FIG. 16, the tolerance analyzing apparatus 11 determines that the assembled location with the assembly location item number 1 belongs to the first datum, the assembled location with the assembly location item number 2 belongs to the second datum, and the assembled location with the assembly location item number 3 belongs to the third datum. The tolerance analyzing apparatus 11 then designates colors of the features of the determined first through third datums.

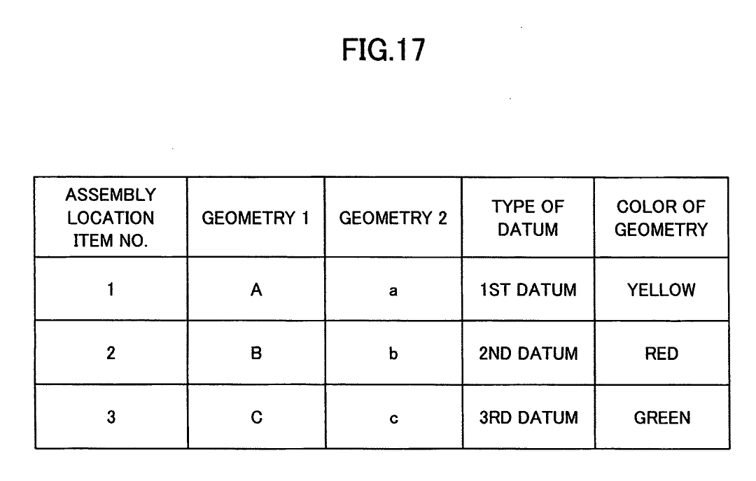

FIG. 17 illustrates an example of color coordinate information for designating the colors of the features of the first through third datums. In the color coordinate information, “geometry 1”, “geometry 2”, “datum type”, and “geometry color” are set for the assembly locations. In the example of FIG. 17, yellow is designated for the features of the first datum, red is designated for the features of the second datum, and green is designated for the features of the third datum. The color coordinate information of FIG. 17 is used for providing instructions for designating the colors of the features of components on the CAD apparatus 10 and the viewer apparatus 12.

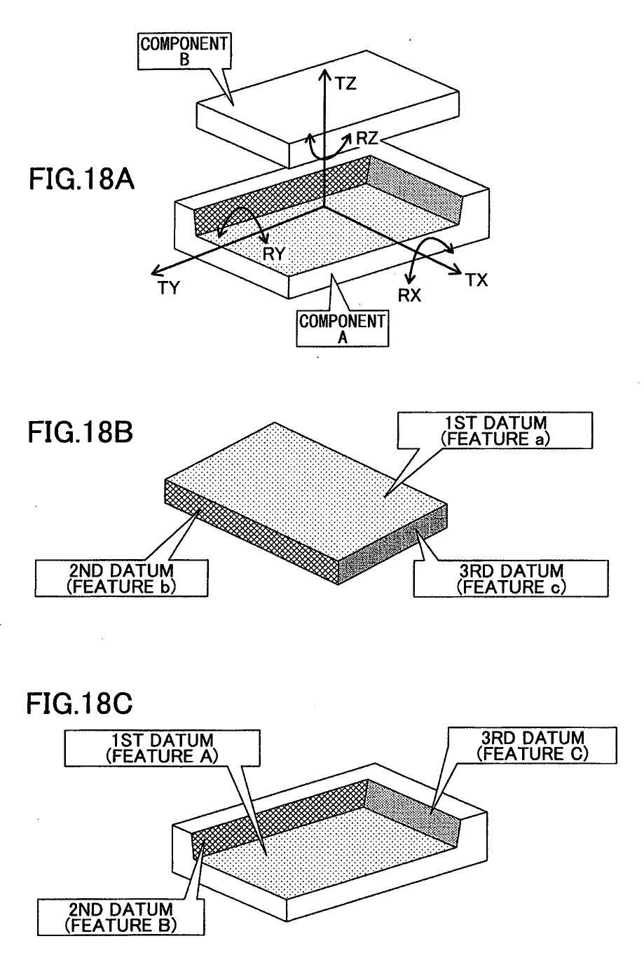

FIGS. 18A through 18C illustrate an example of the components A and B for which the geometry colors are designated depending on the determined datum type. FIG. 18B illustrates the component B, while FIG. 18C illustrates the component A. Specifically, yellow is designated for the features (A, a) of the first datum, red is designated for the features (B, b) of the second datum, and green is designated for the features (C, c) of the third datum.

After the assembly definition is made and the degrees of freedom are defined for all components, the tolerance analyzing apparatus 11 converts a component assembly order based on the attribute information contained in the constituent component tree information arranged in accordance with the assembly order, and then finalizes the converted component assembly order. The attribute information indicates the relationship between the constituent components.

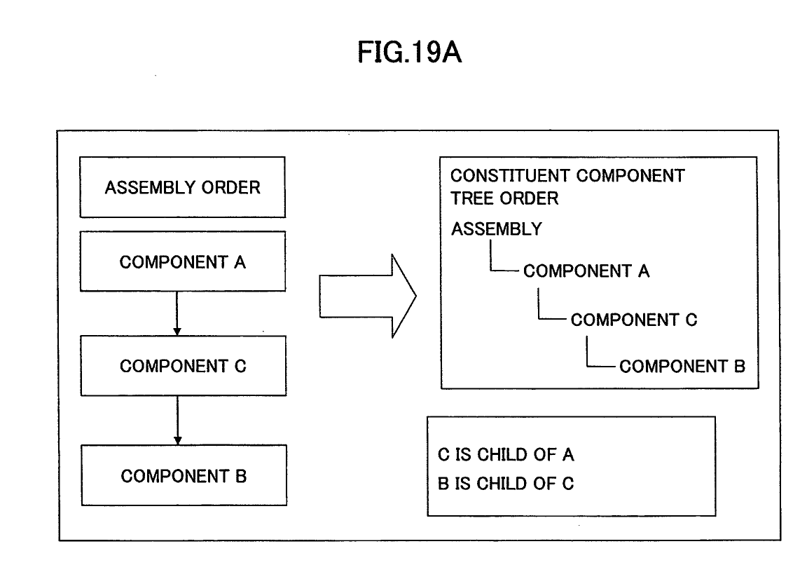

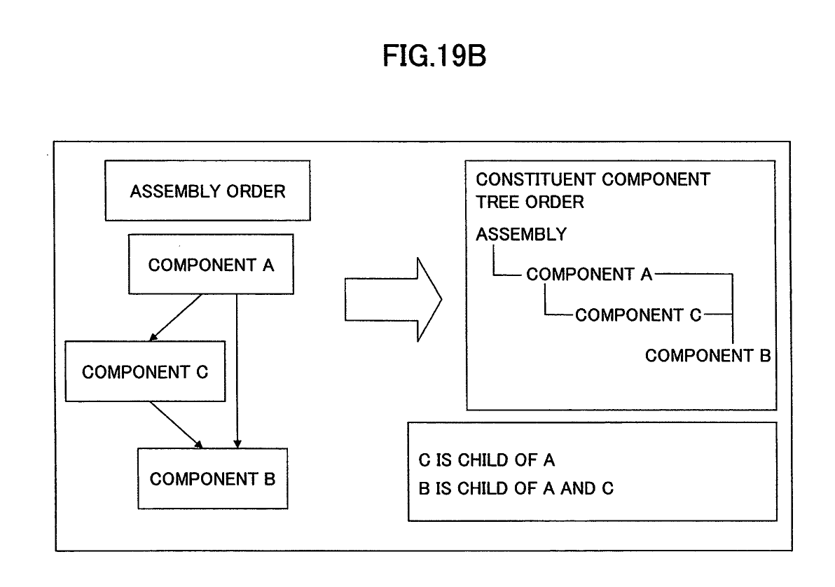

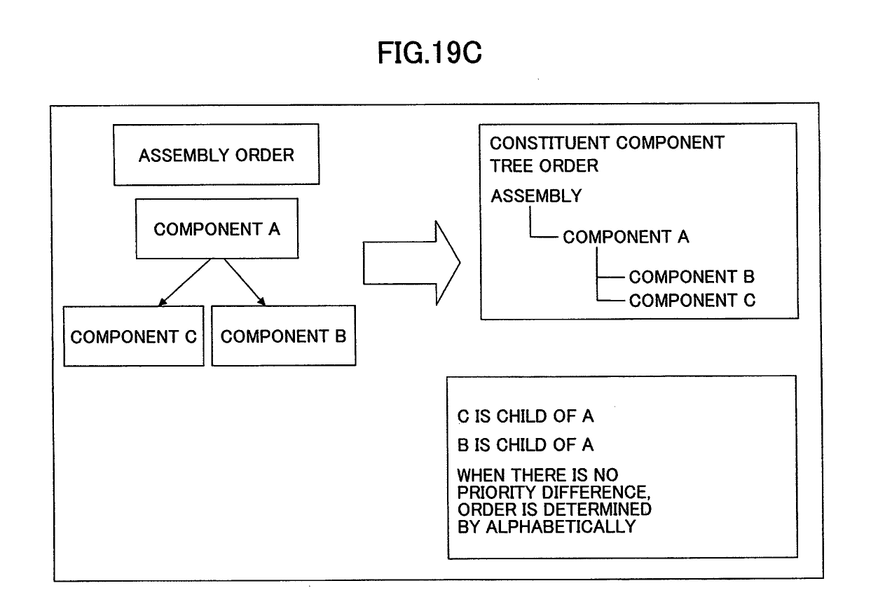

FIGS. 19A through 19C illustrate examples of the constituent component tree information arranged in accordance with the assembly order. In these figures, the arrows indicate a parent-child relationship of the components. FIG. 19A is an example where a component C is a child of the component A, and a component B is a child of the component C. FIG. 19B is an example where the component C is a child of the component A, and the component B is a child of the components A and C. FIG. 19C is an example where the component C is a child of the component A, and the component B is a child of the component A. When there is no priority difference in the relationship, such as between the components B and C in FIG. 19C, the assembly order may be determined in order of the component name.

The tolerance analyzing apparatus 11 collates the names of the constituent component tree information based on the finalized assembly order with the component names of the constituent component tree information of the CAD apparatus 10, and then allocates an assembly order attribute to the constituent components of the constituent component tree information of the CAD apparatus 10 that have corresponding component names.

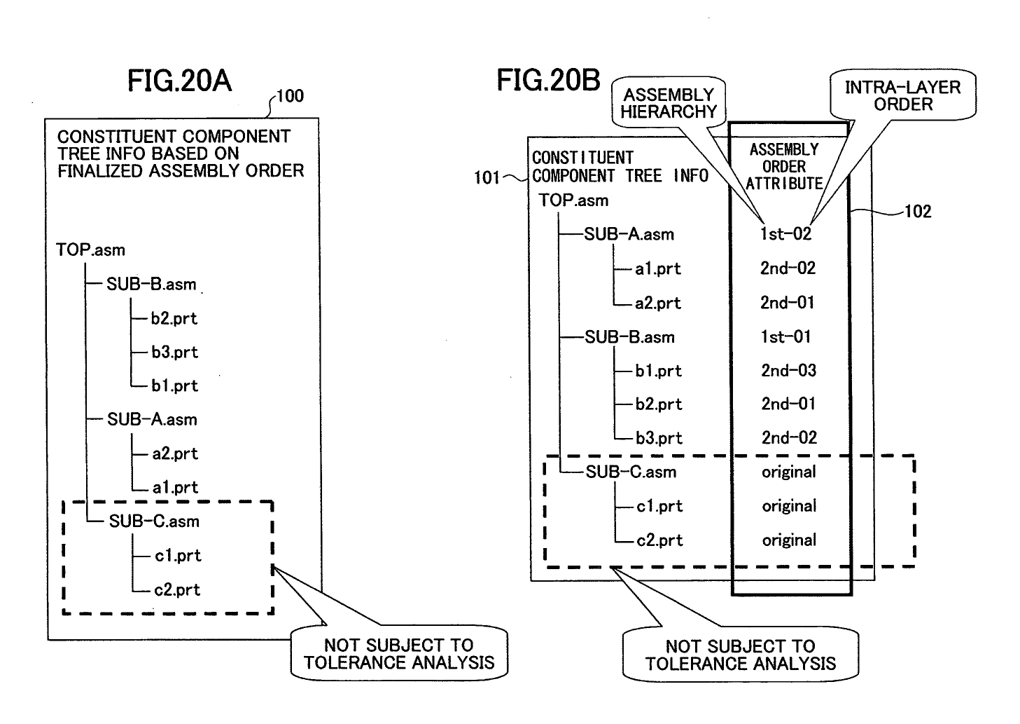

FIGS. 20A and 20B illustrate a process of allocating an assembly order attribute to a constituent component of the constituent component tree information of the CAD apparatus. The constituent component tree information 100 is based on the assembly order finalized by the tolerance analyzing apparatus 11 (FIG. 20A). The constituent component tree information 101 is in the CAD apparatus 10 (FIG. 20B). The constituent component tree information 100 includes components that are not subject to tolerance analysis.

The tolerance analyzing apparatus 11 collates the component names of the constituent component tree information 100 based on the finalized assembly order with the component names of the constituent component tree information 101 of the CAD apparatus 10. The tolerance analyzing apparatus 11 then allocates an assembly order attribute 102 based on the finalized assembly order to the constituent components of the constituent component tree information 101 of the CAD apparatus 10 that have corresponding component names.

The assembly order attribute 102 includes an assembly hierarchy and an intra-layer order. For example, “1st-02” in the assembly order attribute 102 indicates an assembly hierarchy “1st” and the intra-layer order “02”. In the constituent component tree information 101 of the CAD apparatus 10, for the components not subject to tolerance analysis, an assembly order attribute 102 is allocated such that the constituent component tree information 101 of the CAD apparatus 10 can be maintained.

When tolerance analysis is performed for plural assembly locations and there are plural different assembly orders and assembly definitions, the designer may be allowed to select the assembly definition information that is allocated based on the tolerance analysis result and a priority according to design. When tolerance analysis is not performed for all of the constituent components, the constituent components for which the tolerance analysis has not been performed may be allocated an assembly order attribute “original” that would maintain the constituent component tree information 101 of the CAD apparatus 10.

The viewer apparatus 12 receives from the CAD apparatus 10 the three-dimensional CAD data, the assembly order attribute information, and the color information of the features of the color-coded first through third datums, and creates an assembly instruction video of an assembly order that reduces the build-up of dimensional tolerances in the product, for example.

In this case, the viewer apparatus 12 sorts the constituent component tree information 101 of the CAD apparatus 10 to which the assembly order attribute 102 has been allocated, using the assembly order attribute 102 as a keyword in order to arrange the order of the components under the first layer (1st), second layer (2nd), . . . , and the N-th layer of the constituent component tree information 102.

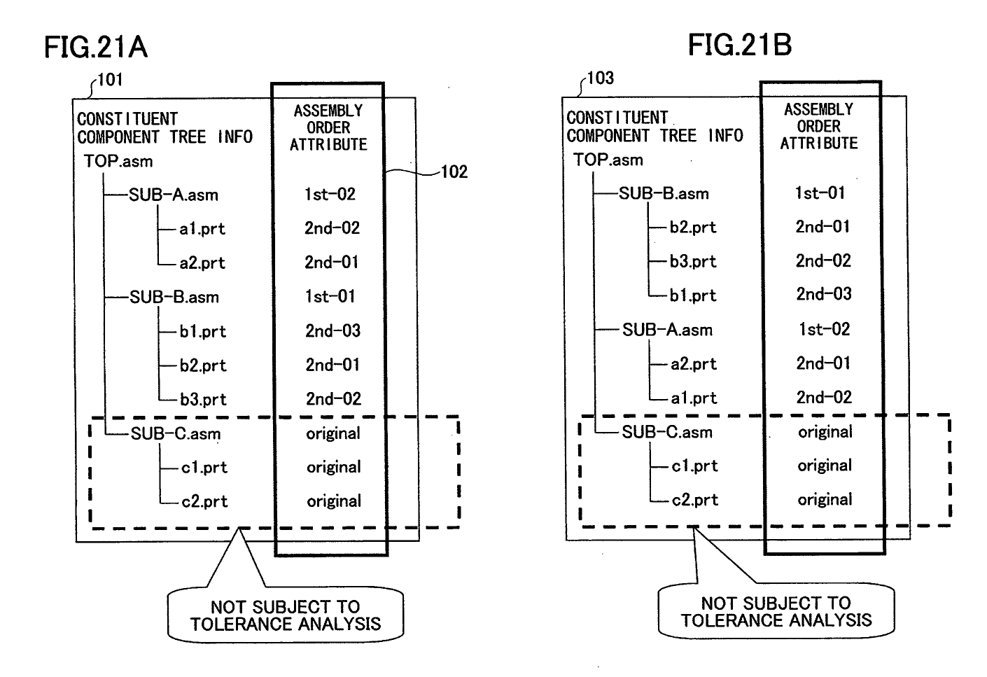

FIGS. 21A and 21B illustrate an example of a process of restructuring the constituent component tree information of the viewer apparatus from the constituent component tree information of the CAD apparatus to which the assembly order attributes have been allocated (FIG. 21A). The viewer apparatus 12 sorts the layers of the constituent component tree information 101 of the CAD apparatus 10 to which the assembly order attribute 102 is allocated (FIG. 21A), using the assembly order attribute 102 as a keyword, thus restructuring the constituent component tree information 103 of the viewer apparatus 12 (FIG. 21B). For the constituent components to which the assembly order attribute “original” is allocated for maintaining the constituent component tree information 101 of the CAD apparatus 10, the constituent component tree information 101 of the CAD apparatus 10 is maintained also in the viewer apparatus 12.

The viewer apparatus 12, in a preliminary process for creating the component assembly instruction video, creates an assembly order list that can reduce the build-up of dimensional tolerances in the product and the like, from the assembly order attribute of the restructured constituent component tree information 103.

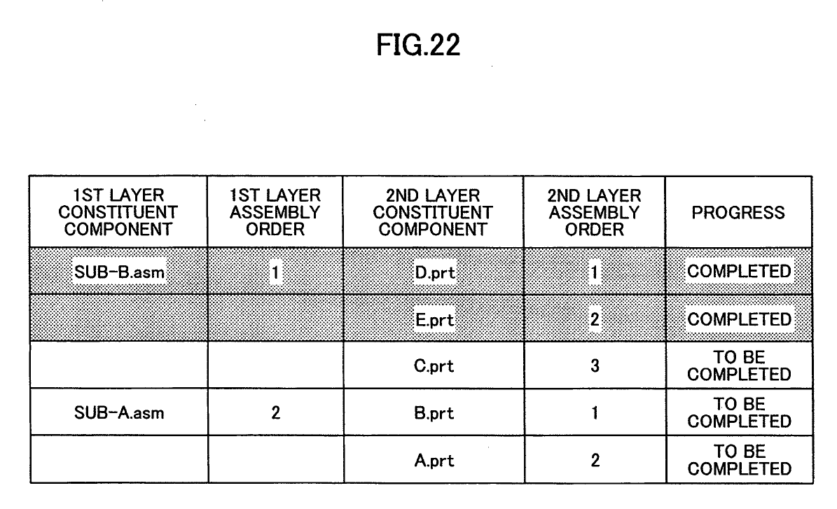

FIG. 22 is an example of the assembly order list that has data items of “first layer constituent component”, “first layer group order”, “second layer constituent component”, “second layer group order”, and “progress”. The viewer apparatus 12, when creating the component assembly instruction video, collates the assembly order list with the names of the constituent components selected by the designer, and removes from the assembly order list the constituent components for which assembly instructions have been correctly issued. When creating the component assembly instruction video, the viewer apparatus 12 may display an alert message if a constituent component that does not correspond to the assembly order list is selected by the designer, thus preventing the creation of an erroneous assembly instruction.

The viewer apparatus 12, when creating the component assembly instruction video, color-codes the features of the first through third datums in order to indicate a detailed assembly location between constituent components. Then, the viewer apparatus 12 acquires from the comment library 62 a comment corresponding to the color of the feature of the first through third datums, such as “First datum”, and inserts the comment in the component assembly instruction video.

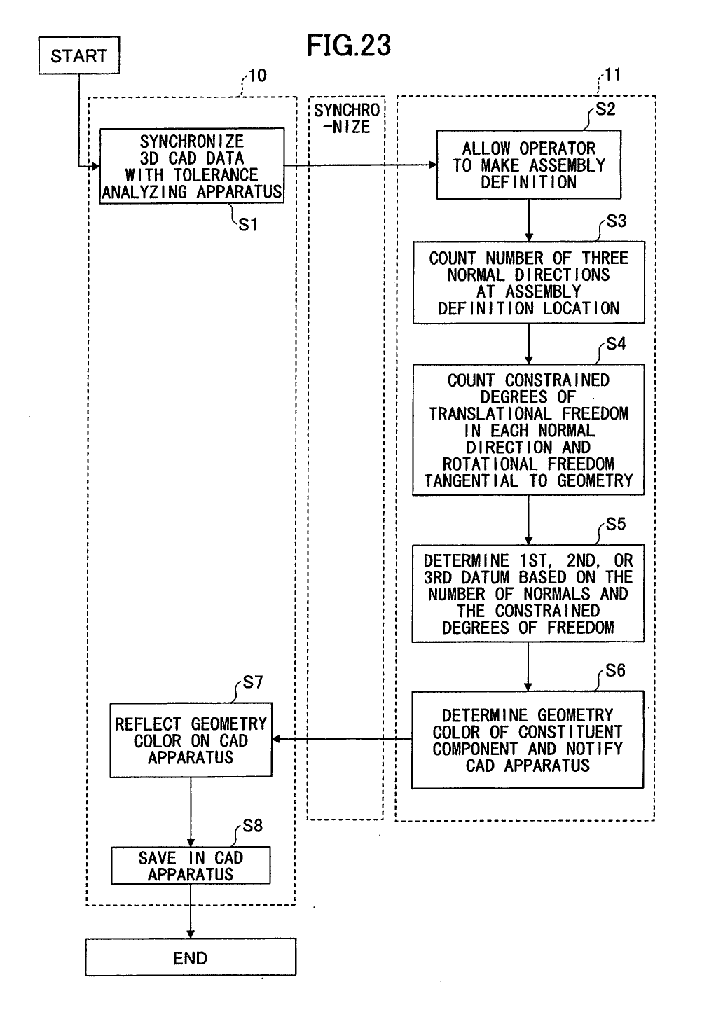

FIG. 23 is a flowchart of a process of determining the first through third datums. In step S1, the CAD apparatus 10 synchronizes the three-dimensional CAD data, which is a result designed by the designer, with the tolerance analyzing apparatus 11. In step S2, the assembly definition unit 51 of the tolerance analyzing apparatus 11 allows the operator (designer) to define an assembly definition and the degrees of freedom.

In step S3, the model information unit 52, by referring to the assembly definition information, counts the number of the three normal directions in each of the assembly locations as the number of the same direction normals. In step S4, the model information unit 52, for the counted three normal directions of each assembly location, counts the number of the constrained degrees of translational freedom in each normal direction and the number of the constrained degrees of rotational freedom about axes perpendicular to the normal (i.e., the number of the constrained degrees of rotational freedom about axes in tangential directions to the feature).

In step S5, the model information unit 52, by referring to the datum determination reference table, determines the datum type (first, second, or third datum) corresponding to the number of the same direction normals, the number of the constrained degrees of translational freedom in the normal direction, and the number of the constrained degrees of rotational freedom about axes perpendicular to the normal that have been counted.

In step S6, the model information unit 52, in accordance with the determined first, second, or third datum, determines the geometry color of the constituent component and gives an instruction to the CAD apparatus 10. In step S7, the CAD apparatus 10 reflects the geometry color in the constituent component. In step S8, the feature/assembly order storage unit 42 of the CAD apparatus 10 stores the geometry color reflected in the constituent component in association with the three-dimensional CAD data.

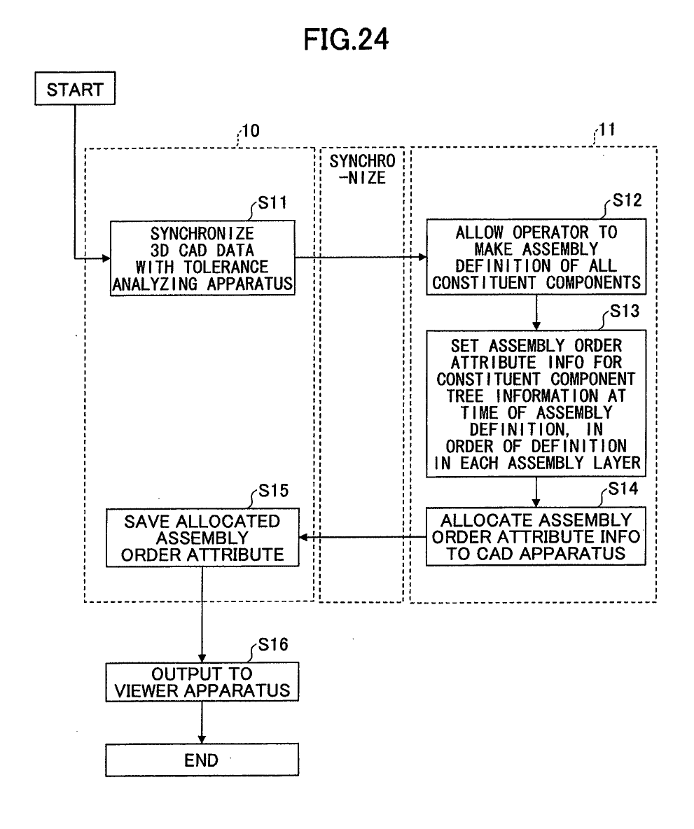

FIG. 24 is a flowchart of a process of converting the component assembly order. In step S11, the CAD apparatus 10 synchronizes the three-dimensional CAD data, i.e. the result of designing by the designer, with the tolerance analyzing apparatus 11. In step S12, the assembly definition unit 51 of the tolerance analyzing apparatus 11 allows the operator (designer) to define an assembly definition and the degrees of freedom.

In step S13, the assembly order converting unit 53 sets assembly order attribute information based on the finalized assembly order for the constituent components of the constituent component tree information based on the finalized assembly order. In step S14, the assembly order converting unit 53 collates the component names of the constituent component tree information based on the finalized assembly order with the component names of the constituent component tree information of the CAD apparatus 10. Then, the assembly order converting unit 53 allocates assembly order attributes based on the finalized assembly order to the constituent components of the constituent component tree information of the CAD apparatus 10 that have corresponding component names.

In step S15, the feature/assembly order storage unit 42 of the CAD apparatus 10 stores the three-dimensional CAD data and the assembly order attribute information. In step S16, the model feature generating unit 41 outputs the three-dimensional CAD data, the assembly order attribute information, and the color information of the features of the color-coded first through third datums to the viewer apparatus 12.

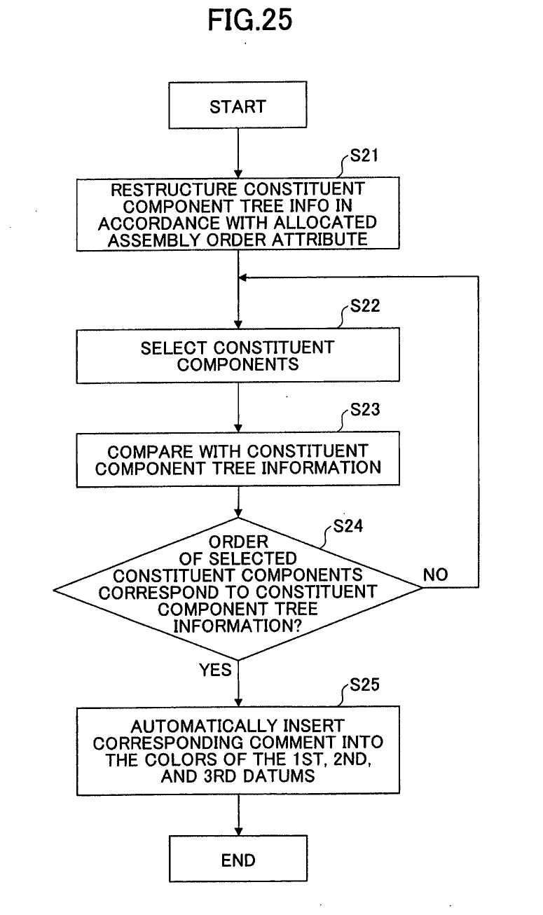

FIG. 25 is a flowchart of a process of creating the assembly order list. In step S21, the model display unit 61 of the viewer apparatus 12 sorts the layers of the constituent component tree information of the CAD apparatus 10 to which the assembly order attribute has been allocated, using the assembly order attribute as a keyword, thus restructuring the constituent component tree information of the viewer apparatus 12. The model display unit 61, in a preliminary process for the creation of the component assembly instruction video, generates an assembly order list that reduces the build-up of dimensional tolerances in the assembled product and the like, from the assembly order attribute of the restructured constituent component tree information.

In step S22, the model display unit 61 allows the designer to select constituent components. In step S23, the model display unit 61 collates the assembly order list with the names of the constituent components selected by the designer. If the constituent components are selected by the designer in a different order from that of the assembly order list, the model display unit 61 displays an alert message in step S24 and then the routine returns to step S22.

When the constituent components are selected by the designer in the same order as that of the assembly order list, the model display unit 61 in step S25 acquires from the comment library 62 a comment corresponding to the color of the features of the first, the second, or the third datum, and inserts the comment in the component assembly instruction video.

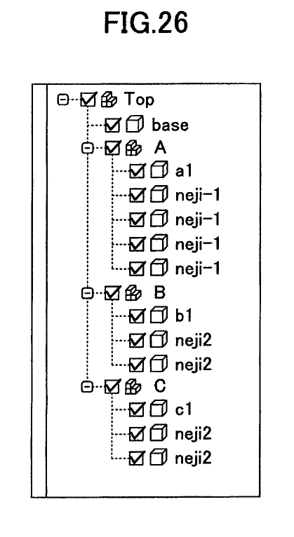

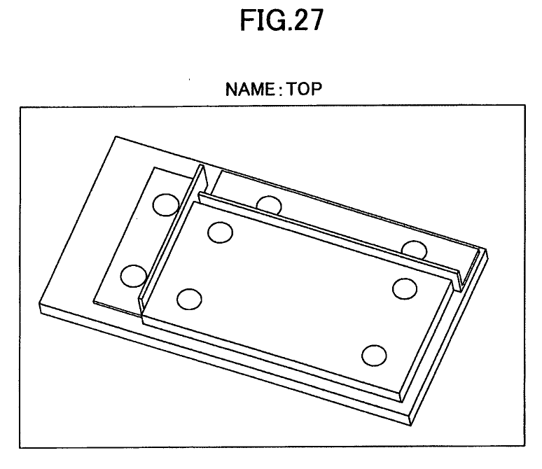

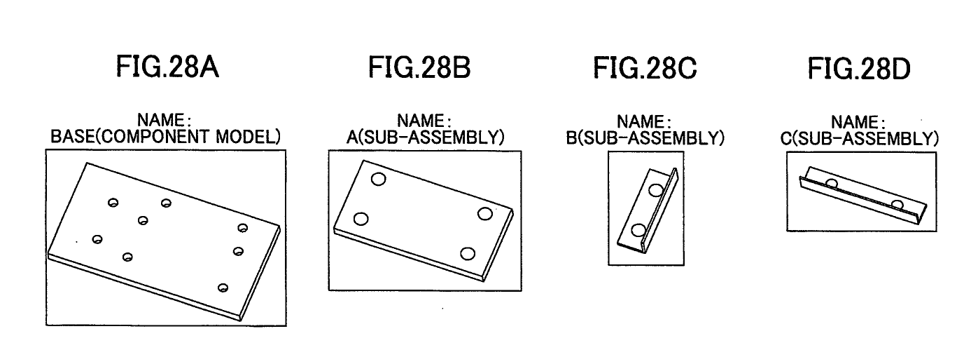

FIG. 26 illustrates an example of the constituent component tree information of the CAD apparatus. FIG. 27 illustrates an example of an assembly model of a highest order. FIGS. 28A through 28D illustrate a component model and sub-assemblies of the second layer. The assembly model of the highest order of FIG. 27 has a name “TOP”. The assembly model of the highest order depicts an image of assembled constituent components. In FIGS. 28A through 28D, the component model has a name “base”, and the sub-assemblies have names “A” through “C”.

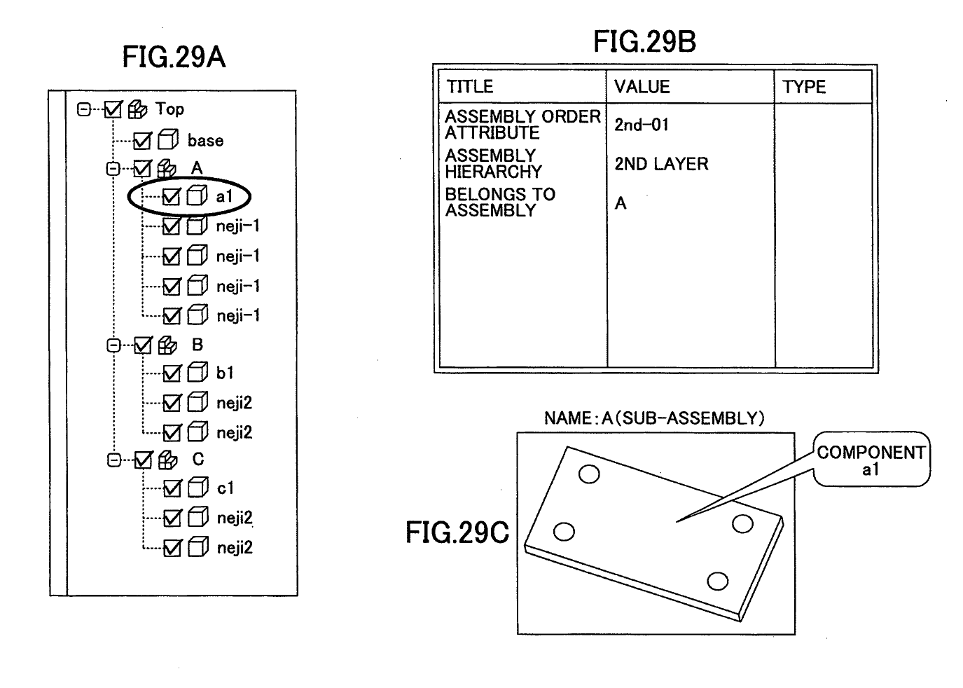

FIGS. 29A through 29C illustrate an example of the attribute information in the constituent component tree information (FIG. 29A). Specifically, FIG. 29B illustrates an example of the attribute information of a component “a1” under the sub-assembly model “A”. In the attribute information of FIG. 29, the component “a1” is under the sub-assembly model “A” of the second layer (see FIG. 29A), the attribute indicating that the component (FIG. 29C) is the first in group order in the sub-assembly model “A” of the second layer.

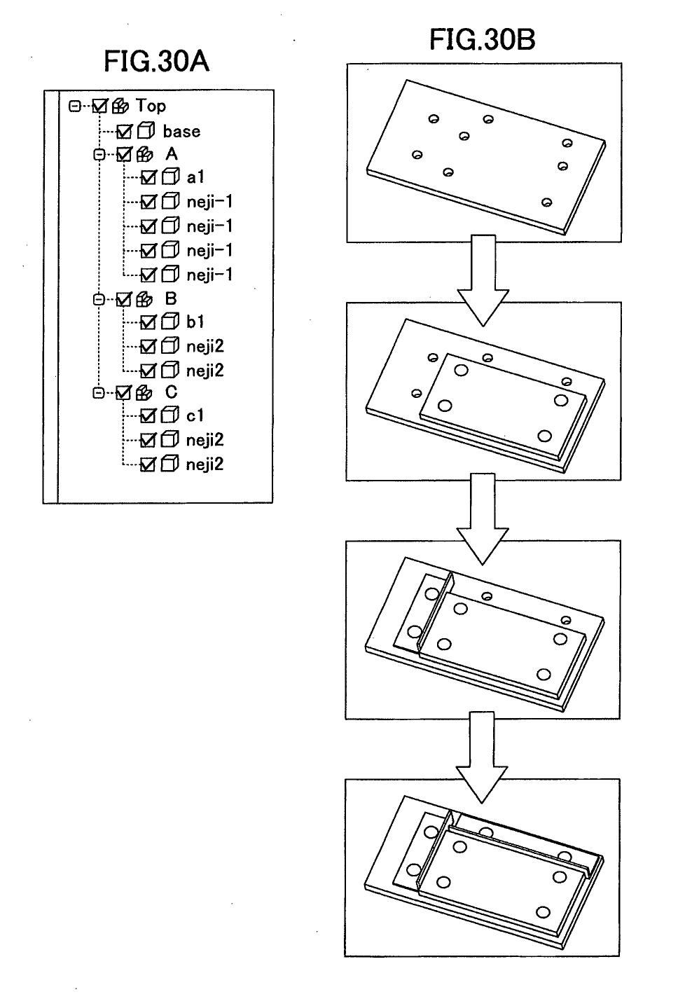

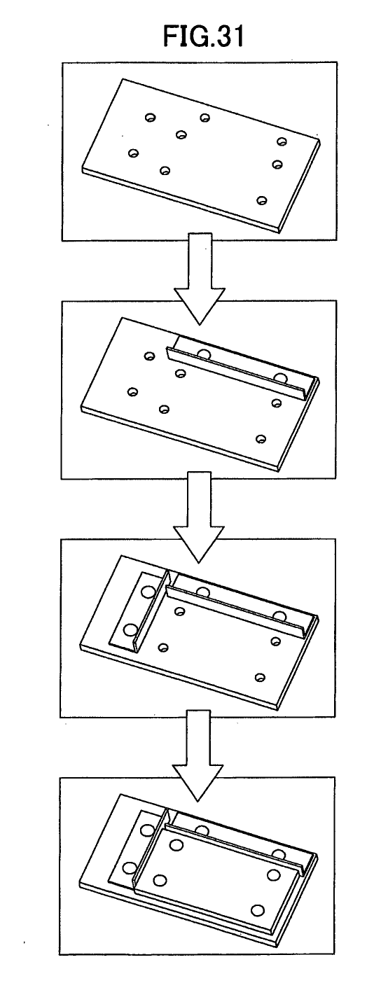

FIG. 30B illustrates an example of an assembly order in which constituent components are assembled according to the constituent component tree information of the CAD apparatus 10 (FIG. 30A). FIG. 31 illustrates an example of an assembly order in which the constituent components are assembled according to the constituent component tree information of the tolerance analyzing apparatus 11. The assembly order of FIG. 31 reduces the build-up of dimensional tolerances in the assembled product and the like.

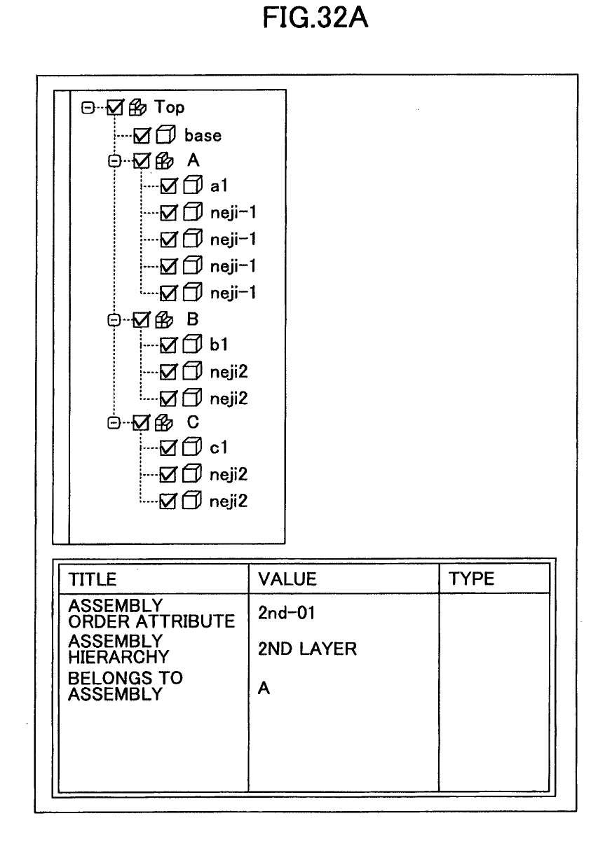

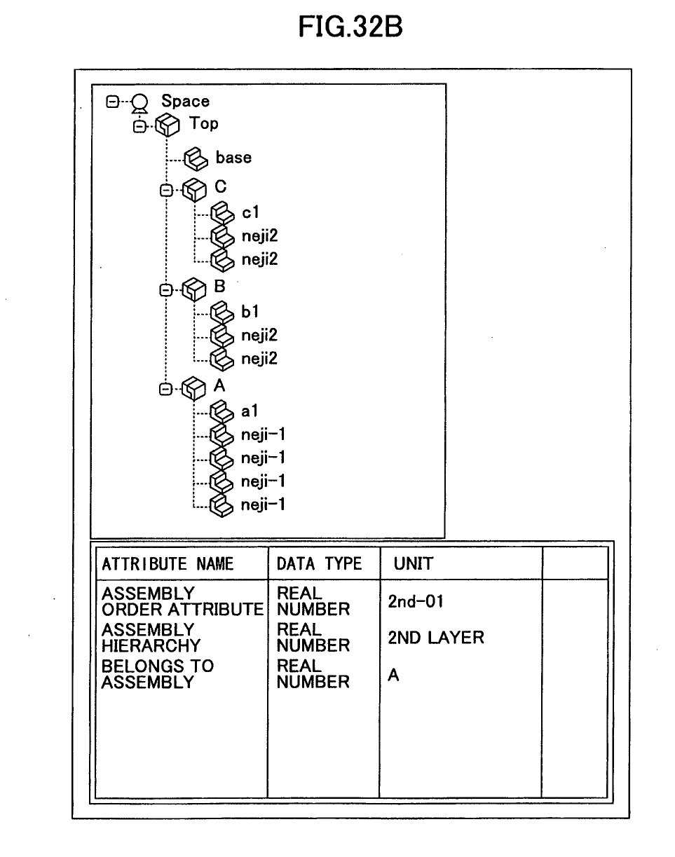

FIG. 32A illustrates an example of the constituent component tree information and the attribute information of the CAD apparatus 10, which correspond to the assembly order of FIG. 30. FIG. 32B illustrates an example of the constituent component tree information and the attribute information of the viewer apparatus, which correspond to the assembly order of FIG. 31. The constituent component tree information of FIG. 32B is restructured into an assembly order that reduces the build-up of dimensional tolerances in the assembled product and the like.

### [b] Second Embodiment

### (System Structure)

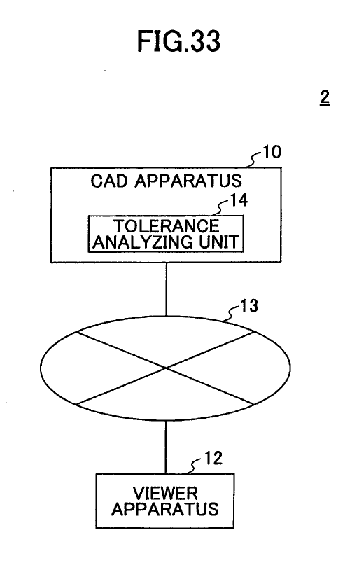

FIG. 33 illustrates an assembly instruction generating system 2 according to another embodiment of the present invention. The assembly instruction generating system 2 includes a CAD apparatus 10 and a viewer apparatus 12 which are connected via a network 13 which may include the Internet or a LAN, so that data can be communicated between the CAD apparatus 10 and the viewer apparatus 12. The CAD apparatus 10 includes a tolerance analyzing unit 14 corresponding to the tolerance analyzing apparatus 11 of the assembly instruction generating system 1.

The assembly instruction generating system 2 of FIG. 33 differs from the assembly instruction generating system 1 of FIG. 1 in that the tolerance analyzing apparatus 11 is not included and that a tolerance analyzing unit 14 corresponding to the tolerance analyzing apparatus 11 is included in the CAD apparatus 10.

One of the problems to be solved for quality improvement between the upper process of design and the like and the lower process of manufacture or assembly is how efficiently the result of tolerance analysis can be reflected in the generation of component assembly instructions. In accordance with the foregoing embodiments of the present invention, an assembly order is optimized by the tolerance analyzing apparatus 11 or the tolerance analyzing unit 14 such that the build-up of dimensional tolerances can be reduced. The optimized assembly order can be readily applied for an external apparatus such as the viewer apparatus 12. Thus, in accordance with the embodiments of the present invention, optimized dimensional tolerances can be set and an assembly order that reduces the build-up of dimensional tolerances can be provided, so that improved quality of the designed product can be achieved while the number of steps for generating the assembly instructions can be significantly reduced.

An assembly order converting method according to an embodiment of the present invention may be realized by using a Web service. An assembly order converting program according to an embodiment of the present invention may be provided in the form of a software package or may be downloaded from a Web site. The assembly order converting program may be realized by a batch file and the like.

The assembly component selectable model information unit 52 may include a determination unit and an output unit. The model feature generating unit 41 may include a design data generating unit. The model display unit 61 may include a restructuring unit, a list generating unit, an alerting unit, and a comment inserting unit. The CAD apparatus 10 may include a designing apparatus.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present inventions have been described in detail, it should be understood that the various changes, substitutions, and alterations could be made hereto without departing from the spirit and scope of the invention.

What is claimed is:

1. A tolerance analyzing apparatus for performing a tolerance analysis based on design data, the apparatus comprising:
an assembly definition unit configured to allow a user to make an assembly definition and define a degree of freedom for a constituent component;
a determination unit configured to determine a datum type corresponding to a count value based on a datum determination reference table,
wherein the determination unit is configured to obtain the count value by counting a number of normals having the same direction at an assembly location of the constituent component, a constrained degree of translational freedom in the normal direction, and a constrained degree of rotational freedom about an axis perpendicular to the normal based on the assembly definition and the degree of freedom of the constituent component; and
an output unit configured to output the datum type determined by the determination unit.

2. The tolerance analyzing apparatus according to claim 1, further comprising:
an assembly order converting unit configured to set, for the constituent component in constituent component tree information based on an assembly order finalized according to the assembly definition of the constituent component, assembly order attribute information based on the finalized assembly order, and configured to allocate an assembly order attribute based on the finalized assembly order to the constituent component having a corresponding name in the constituent component tree information of a designing apparatus.

3. The tolerance analyzing apparatus according to claim 1, wherein the datum determination reference table is configured to uniquely associate the number of the same direction normals at the assembly location of the constituent component, the constrained degree of translation freedom in the normal direction, and the constrained degree of rotational freedom about an axis perpendicular to the normal with first through third datums as the datum type.

4. The tolerance analyzing apparatus according to claim 1, wherein the output unit is configured to determine a color of the assembly location of the constituent component in accordance with first through third datums as the datum type determined by the determination unit.

5. A computer-aided designing apparatus comprising:
a design data generating unit configured to generate design data by enabling a user to make a design and;
a tolerance analyzing unit configured to perform tolerance analysis based on the design data,
the tolerance analyzing unit including:
an assembly definition unit configured to allow the user to make an assembly definition and define a degree of freedom for a constituent component;
a determination unit configured to determine a datum type corresponding to a count value based on a datum determination reference table,
wherein the determination unit is configured to obtain the count value by counting a number of same direction normals at an assembly location of the constituent component, a constrained degree of translational freedom in the normal direction, and a constrained degree of rotational freedom about an axis perpendicular to the normal based on the assembly definition and the degree of freedom of the constituent component; and
an output unit configured to output the datum type determined by the determination unit.

6. A viewer apparatus for generating an assembly instruction concerning an assembly order of constituent components, the apparatus comprising:
a restructuring unit configured to restructure constituent component tree information by sorting constituent components in the constituent component tree information according to an assembly order attribute allocated to the constituent components based on the assembly order,
a list generating unit configured to generate an assembly order list for the constituent components based on the constituent component tree information restructured by the restructuring unit; and
an alerting unit configured to display an alert message when the constituent components are selected by a user in an order different from the assembly order list during the generation of the assembly instruction of the assembly order for the constituent components.

7. The viewer apparatus according to claim 6, further comprising a comment inserting unit configured to insert a comment indicating a datum type corresponding to a color of an assembly location of the constituent components into the assembly location of the constituent components when generating the assembly instruction of the assembly order for the constituent components.

8. An assembly order converting method implemented by a tolerance analyzing apparatus for performing tolerance analysis based on design data, the method comprising:
allowing a user to make an assembly definition and define a degree of freedom for a constituent component;
obtaining a count value by counting a number of same direction normals at an assembly location of the constituent component, a constrained degree of translational freedom in the normal direction, and a constrained degree of rotational freedom about an axis perpendicular to the normal based on the assembly definition and the degree of freedom of the constituent component;
determining a datum type corresponding to the count value based on a datum determination reference table;
outputting the datum type determined by the determining;
finalizing an assembly order based on the assembly definition of the constituent component;
setting assembly order attribute information based on the finalized assembly order for the constituent component in constituent component tree information based on the finalized assembly order; and
allocating an assembly order attribute based on the finalized assembly order to the constituent component having a corresponding name in the constituent component tree information of a designing apparatus.

9. A non-transitory computer-readable recording medium storing an assembly order converting program for causing a tolerance analyzing apparatus for performing tolerance analysis based on design data to function as:
an assembly definition unit configured to allow a user to make an assembly definition and define a degree of freedom for a constituent component;
a determination unit configured to determine a datum type corresponding to a count value based on a datum determination reference table,
wherein the determination unit is configured to obtain the count value by counting a number of same direction normals at an assembly location of the constituent component, a constrained degree of translational freedom in the normal direction, and a constrained degree of rotational freedom about an axis perpendicular to the normal based on the assembly definition and the degree of freedom of the constituent component;
an output unit configured to output the datum type determined by the determination unit; and
an assembly order converting unit configured to set, for the constituent component in constituent component tree information based on an assembly order that is finalized according to the assembly definition of the constituent component, assembly order attribute information based on the finalized assembly order, and configured to allocate an assembly order attribute based on the finalized assembly order to the constituent component having a corresponding name in the constituent component tree information of a designing apparatus.
